(19) United States
(12) Patent Application Publication
(10) Pub. No.: US 2007/0152907 A1
(43) Pub. Date: Jul. 5, 2007

(54) STRUCTURE OF METAL HOUSING FOR ANTENNA CONNECTOR

(75) Inventor: HSI-CHUAN WONG, BANCIAO (TW)

Correspondence Address: T-CONN PRECISION CORPORATION, 4F-18, NO. 121, SEC. 1, CHONG QING SOUTH ROAD, TAIPEI, 100, TW

(73) Assignee: T-CONN PRECISION CORPORATION, BANCIAO (TW)

(21) Appl. No.: 11/307,509

(22) Filed: Feb. 10, 2006

(30) Foreign Application Priority Data
Dec. 30, 2005 (TW) 094223204

(51) Int. Cl. H01Q 1/50

(52) U.S. Cl. 343/906; 343/702

(57) ABSTRACT

A structure of a metal housing for an antenna connector is provided. The metal housing comprises a base, a sleeve and a clamp. The sleeve is connected to one end of the base and the clamp is formed on the other end of the base. Two holes are formed at one end of the base where the clamp formed. Two plates extend from the sleeve close to the clamp to form an opening. A cable comprising a conducting terminal may be inserted through the opening and the conducting terminal may be precisely positioned and securely clamped to the metal housing.

This application claims the priority benefit of a Taiwan patent application No. 094223204 filed on Dec. 30, 2005.

### FIELD OF THE INVENTION

The present invention generally relates to an antenna connector, and more particularly to a structure of a metal housing of an antenna connector.

### DESCRIPTION OF RELATED ART

A conventional antenna connector comprises at least a connecting part and a terminal disposed on an insulating housing, wherein the terminal comprises a connection pin that protrudes from the insulating housing. The insulating housing is encased into a metal housing. The connecting part and the connecting pin can be connected from the outside. A card-locking component is disposed under the insulating housing for locking a connecting hole on a circuit board. The metal housing is grounded via a grounding component. A positioning layer is disposed on the grounding component, wherein the positioning layer extends under the insulating housing. The positioning layer is positioned on a grounding hole of the circuit board. The card locking component and the metal housing are two separate components. A fixing member is disposed on the card-locking component for locking and fixing to an insulator. As the conventional connector is small in size and comprises complicated components, the assembling procedures are not only time consuming but also complicated. Thus, the fabrication yield and the reliability of antenna connector are decreased.

In view of the deficiencies of conventional structure described above, it is highly desirable to provide a structure of an antenna connector that can be assembled with comparatively simple procedure so as to substantially promote the fabrication yield and the reliability of the antenna connector so that the quality of signal transmission there-through may be effectively ensured.

### SUMMARY OF THE INVENTION

The primary objective of the present invention is to provide a structure of metal housing for an antenna connector for shielding electromagnetic waves so that the quality of signal transmission there-through may be effectively promoted.

Another objective of the present invention is to provide a structure of metal housing for an antenna connector such that the fabrication yield may be effectively promoted.

To achieve the above objectives and other objectives of the present invention, a structure of a metal housing for an antenna connector is provided. The metal housing comprises a base, a sleeve and a clamp. The sleeve is connected to one end of the base and the clamp is formed on the other end of the base. Two holes are formed at one end of the base where the clamp formed. Two plates extend from the sleeve close to the clamp to form an opening. A cable comprising a conducting terminal may be inserted through the opening and the conducting terminal may be precisely positioned and securely clamped to the metal housing. Consequently, not only the fabrication yield of the antenna connector is effectively promoted but also the quality of signal transmission due to the shielding effect of the metal housing may be effectively promoted.

### BRIEF DESCRIPTION OF THE DRAWINGS

FIG. 1 shows a perspective view of a structure of an antenna connector according to an embodiment of the present invention.

FIG. 2 shows a procedure of assembling a cable to the antenna connector according to an embodiment of the present invention.

FIG. 3 shows a perspective view of the antenna connector after assembling cable to the antenna connector according to an embodiment of the present invention.

FIG. 4 shows a sectional side view of FIG. 3.

### DETAILED DESCRIPTION OF THE EMBODIMENTS

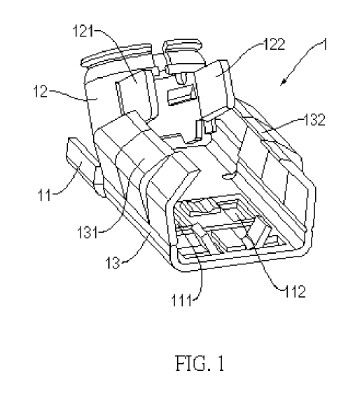

Referring to FIG. 1, the metal housing 1 according to the present invention includes a base 11, a sleeve 12 and a clamp 13. The sleeve 12 is disposed at one end of the base 11 and the clamp 13 is disposed at the other end of the base 11. Two plates 121 and 122 extend from the sleeve 12 close to the clamp 13 to form an opening that communicates with the opening of the sleeve 12. The clamp 13 comprises two plates 131 and 132 that extend upwards with end portions thereof converging toward each other. The two plates 131 and 132 are adopted for clamping a cable. Two holes 111 and 112 are formed in the base 11 and located close to the clamp 13. The base 11, the sleeve 12 and the clamp 13 may be integrally formed.

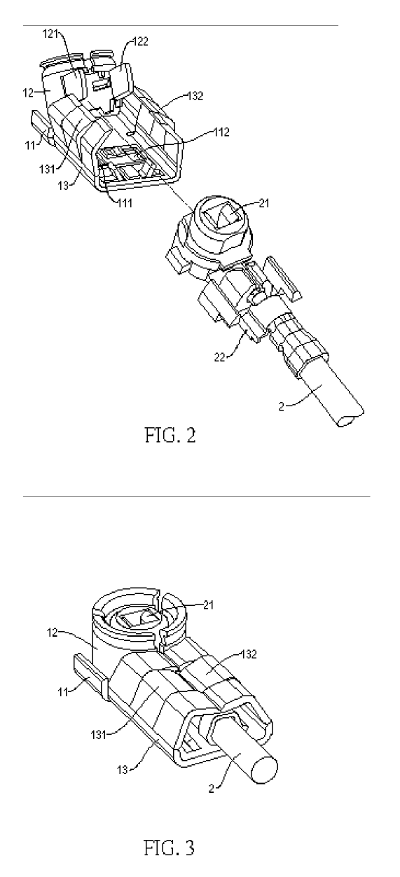

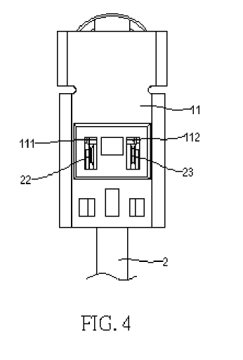

Referring to FIG. 2, 3, 4, to assemble a cable 2 comprising a conducting terminal 21 to the antenna connector of the present invention, the conducting terminal 21 is inserted through the opening formed between the two plates 121 and 122 and positioned inside the sleeve 12. Next, the two plates 121 and 122 are pressed downwards such that the sleeve 12 is aligned to the plane of conducting terminal 21. Next, the two plates 131 and 132 of the clamp 13 are pressed to clamp the two plates 121 and 122 of the sleeve 12. Thus, the cable 2 may be properly enveloped and fixed by the two plates 131 and 132 of the clamp 13.

Furthermore, two clamping plates 22 and 23 corresponding to the holes 111 and 112 are disposed under the conducting terminal 21. After the conducting terminal 21 of the cable 2 is positioned inside the sleeve 12, the two clamping plates 22 and 23 are inserted into the holes 111 and 112 and pressed downward to securely fix the cable 2 to the metal housing 1. Thus, after the cable 2 is fixed to the metal housing 1, the conducting terminal 21 may not be pulled out of the metal housing 1 due to accidental external force applied to the cable 2.

Accordingly, the structure of the antenna connector of the present invention has at least the following advantages.

Because the base 11, the sleeve 12 and the clamp 13 of the metal housing 1 are integrally formed, therefore the metal housing 1 may provide a better shielding effect to shield the electromagnetic waves.

Because the cable 2 is securely clamped to the metal housing 1 using the clamp 13 and the plates 131 and 132, and therefore the conducting terminal 21 of the cable 2 may not be easily dislodged from the metal housing 1 due to accidental terminal force applied to the cable 2.

Although the preferred embodiment of the present invention has been described, various modifications and enhancements may be made without departing from the spirit and scope of the present invention. Accordingly, the invention is not limited except as by the appended claims.

What is claimed is:

1. A structure of a metal housing for an antenna connector, comprising:
a base;
a sleeve, disposed at one end of the base, comprising a first opening; and
a clamp, disposed at another end of the base, wherein two plates extend from the sleeve and located close to the clamp part to form a second opening communicating with the first opening of the sleeve, and wherein a conducting terminal of a cable is inserted into sleeve through the second opening and securely positioned by the clamp.

2. The structure of a metal housing for an antenna connector according to claim 1, wherein two holes are formed in the base and two clamping plates corresponding to the two holes are disposed under the cable so that the cable secured by the clamp, the two clamping plates are inserted into the two holes to securely position the cable to the metal housing.
